(19) United States
(12) Patent Application Publication
(10) Pub. No.: US 2018/0047317 A1
(43) Pub. Date: Feb. 15, 2018

(54) Smart Banner Display

(71) Applicant: Michael Joseph Mahedy, Provo, UT (US)

(72) Inventor: Michael Joseph Mahedy, Provo, UT (US)

(21) Appl. No.: 15/675,732

(22) Filed: Aug. 12, 2017

Related U.S. Application Data
(60) Provisional application No. 62/374,975, filed on Aug. 15, 2016.

(51) Int. Cl. G09F 11/08; G09F 11/10; G09F 17/00

(52) U.S. Cl. CPC G09F 11/08; G09F 17/00; G09F 11/10; G06F 3/0484

(57) ABSTRACT

A smart banner display includes a home base that includes a rotating scroll shaft that raises and lowers a planar member for display. The banner display further includes a controller that communicates with the scroll shaft for actuating the rotation. Various other features may be included to further enhance the smart banner display.

### BACKGROUND

It may be desirable to display a banner, flag, or other signage on certain occasions. For example, it may be desirable to display a country flag to celebrate national holidays. During a local sporting event, it may be desirable to display a sports team banner and support the local team. For marketing purposes, stores may want to display signs for special sales.

It may also be desirable to conceal a banner. When inclement weather is approaching or the sun is setting for the day, one may want to conceal a banner that is on display. Also, after a special event is over, a banner is no longer needed to be on display and therefore the banner may be concealed.

For purposes of control for occasions and events, a need exists for improvements on banner displays.

### SUMMARY

A smart banner display includes a home base and a scroll shaft located within the home base. The scroll shaft is configured to rotate around an axis relative to the home base. A banner is removably attached to the scroll shaft so that the banner is raised and lowered as the scroll shaft rotates. A motor rotates the scroll shaft in any rotational direction based upon communication from a controller.

A method for controlling a smart banner display includes displaying on a user interface one or more input controls related to control of the banner display. Upon receiving a selection of the one or more input controls, the method includes providing the selection to a controller. Based on the selection, the controller performs a banner display action which may include positioning the banner, lighting up the banner, or other banner display action.

Another method for controlling a smart banner display includes monitoring, through an application, external event information. Upon detecting a trigger condition based on one or more events, the method includes performing a banner display action.

### BRIEF DESCRIPTION OF DRAWINGS

FIG. 1 shows a perspective view of an exemplary smart banner display.

FIG. 2 shows a front view of an exemplary smart banner display.

FIG. 3a shows a perspective view of a home base and scroll shaft.

FIG. 3b shows a perspective view of a home base.

FIG. 4 shows a side view of a home base and scroll shaft.

FIG. 5a shows an extruded view of a home base and scroll shaft.

FIG. 5b shows an extruded view of a home base and scroll shaft.

FIG. 6a shows a bottom view of a home base and scroll shaft.

FIG. 6b shows a bottom view of a home base and scroll shaft.

FIG. 7a shows a side view of a home base and scroll shaft.

FIG. 7b shows a top view of an interior of a home base.

FIG. 8a shows a top view of a solar panel on a home base.

FIG. 8b shows a side view of a solar panel on a home base.

FIG. 9a shows a cutout view of a banner housing.

FIG. 9b shows a cutout view of a home base and scroll shaft.

FIG. 10 shows a perspective view of a motor.

FIG. 11 illustrates a diagram of an exemplary networked environment used to implement features presented herein.

FIG. 12 illustrates a diagram of exemplary components used to implement features presented herein.

FIG. 13 illustrates a diagram of an exemplary networked environment used to implement features presented herein.

FIG. 14a illustrates an exemplary user display interface for controlling features of a smart banner display.

FIG. 14b illustrates an exemplary user display interface for controlling features of a smart banner display.

FIG. 14c illustrates an exemplary user display interface for controlling features of a smart banner display.

FIG. 14d illustrates an exemplary user display interface for controlling features of a smart banner display.

FIG. 14e illustrates an exemplary user display interface for controlling features of a smart banner display.

FIG. 14f illustrates an exemplary user display interface for controlling features of a smart banner display.

FIG. 15a illustrates an exemplary flow chart of a method for controlling features of a smart banner display.

FIG. 15b illustrates an exemplary flow chart of a method for controlling features of a smart banner display.

### DETAILED DESCRIPTION

This application claims priority to United States Provisional Patent Application 62/374,975 filed Aug. 15, 2016, which is hereby incorporated by reference.

A smart banner display includes a home base and a scroll shaft located within the home base. The scroll shaft is configured to rotate around an axis relative to the home base. A banner is removably attached to the scroll shaft so that the banner is raised and lowered as the scroll shaft rotates. A motor rotates the scroll shaft in any rotational direction based upon communication from a controller.

A method for controlling a smart banner display includes displaying on a user interface one or more input controls related to control of the banner display. Upon receiving a selection of the one or more input controls, the method includes providing the selection to a controller. Based on the selection, the controller performs a banner display action which may include positioning the banner, lighting up the banner, or other banner display action.

Another method for controlling a smart banner display includes monitoring, through an application, external event information. Upon detecting a trigger condition based on one or more events, the method includes performing a banner display action.

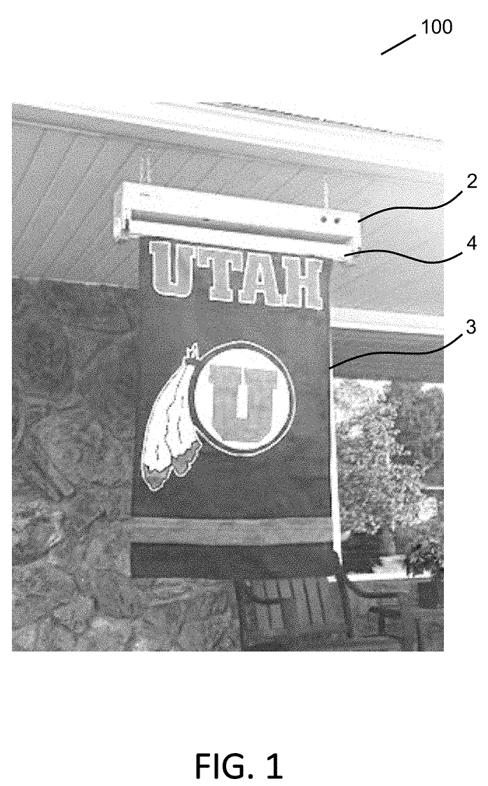

FIG. 1 depicts an exemplary smart banner display 100 including a home base 2, scroll shaft 4, and flexible planar member 3. The home base 2 is a protective shell that holds the scroll shaft 4, planar member 3, and components that control the display of the planar member 3. Such control of the display may be done manually or automatically and may further 100 utilize smart wireless technology that is established in the art.

The banner display is used to raise and lower the planar member 3. A lighting component may be included to light up the display at nighttime or to shine extra light on the planar member 3 and make it stand out. Also, sensory components may be used to sense weather conditions of the 105 display environment and provide weather data to control the display of the planar member 3. Also, various power sources may be utilized to power the device and save energy.

The smart banner display may be hung or attached by the home base to a house, building, or other structure. For example, ropes may tether the 110 home base to a structure. Brackets, bolts, rivets, and other mechanical fasteners may also be used. As shown, the display 100 may be hung underneath an awning of a house.

The planar member 3 may be a banner, flag, signage, or other display unit that is housed in the banner housing. The planar member 3 may be made 115 of cloth, plastic, a plastic-coated fabric, or other material, and of a shape that is typically oblong, square, rectangular, or other shape. The planar member 3 is typically flexible so that it can be rolled or folded or otherwise arranged so as to be concealed within the banner housing. As shown, a sports team banner is used for the display. The scroll shaft 4 and 120 components, including electrical components, motors, sensors, etc. may be operatively connected to the scroll shaft 4. Components may be used to display the planar member 3 as shown.

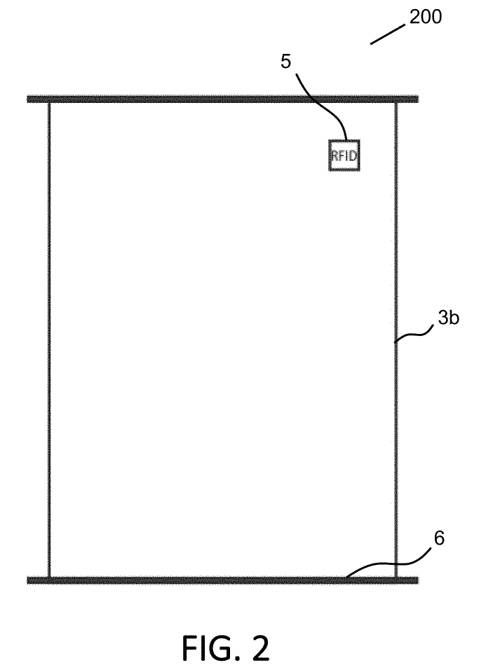

Turning to FIG. 2, a smart banner display 200 is shown that includes flexible planar member 3b having an RFID tag and reader system 5 and a weighted bar 6. The RFID tag 5 is attached on the planar member 3b or within the material of the planar member 3b. The RFID tag 5 is used to identify the planar member 3b and may further be used to track the location of the planar member 3b. Identification of the planar member 3b may include the type of banner, dimensions, display settings and configurations for the type of banner, and other type of information. In this manner, planar members may be exchanged for other planar members and the reader can read the RFID tag 5 to determine the current planar member 3b and/or its settings and configurations being used in the display.

Also shown in FIG. 2 is a weighted bar 6 attached to the planar member 3b. The weighted bar 6 is attached along one side or edge, and in this example, along a bottom edge of the planar member 3b. Other locations are readily observed. The weighted bar 6 serves to pull the planar member down so that it resists bending and makes the planar member more taut which can add to the appearance. An additional weighted bar may be used at or near the top edge, at or near side edges, or at other locations on the member.

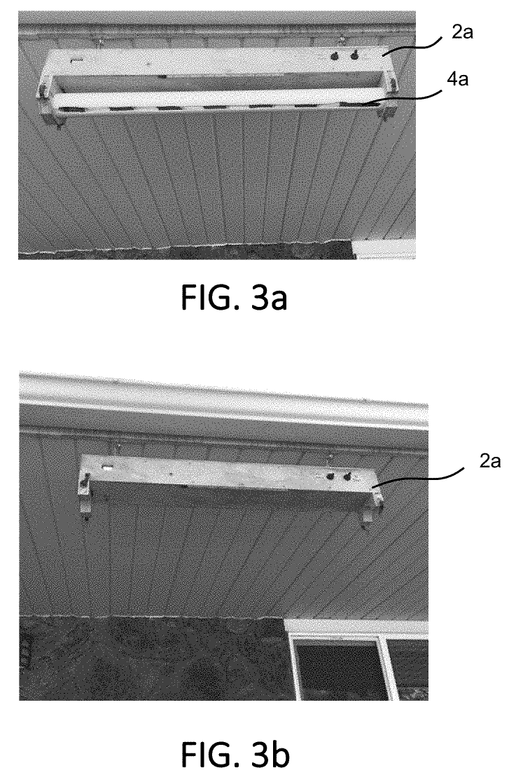

An exemplary banner display includes a home base and banner housing that are separable from each other. FIG. 3a depicts a smart banner display 300 with home base 2a and scroll shaft 4a, but no planar member. FIG. 3b depicts the home base 2a with the banner housing removed.

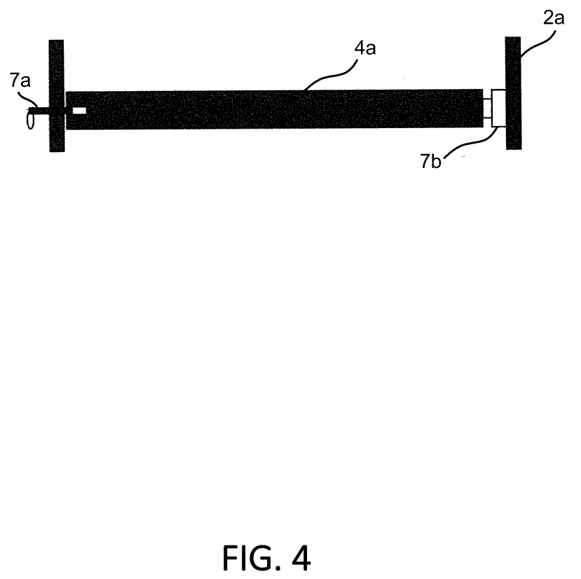

A mechanical fastening structure may be used to attach the banner housing to the home base. FIG. 4 shows an exemplary mechanical fastening structure in the form of a bolt 7a that is used to attach an end of the scroll shaft 4a to the home base 2a. The bolt 7a is attached to an end of the scroll shaft 4a and may be inserted or slidably engaged into an insertion opening of the home base 2a to hold the banner housing in place. The other end of the scroll shaft 4a includes an end that fits within a recessed structure 7b of the home base 2a.

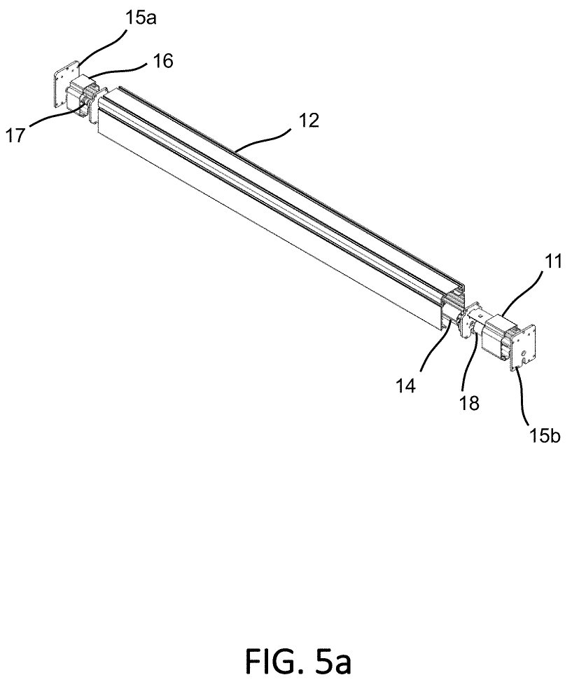

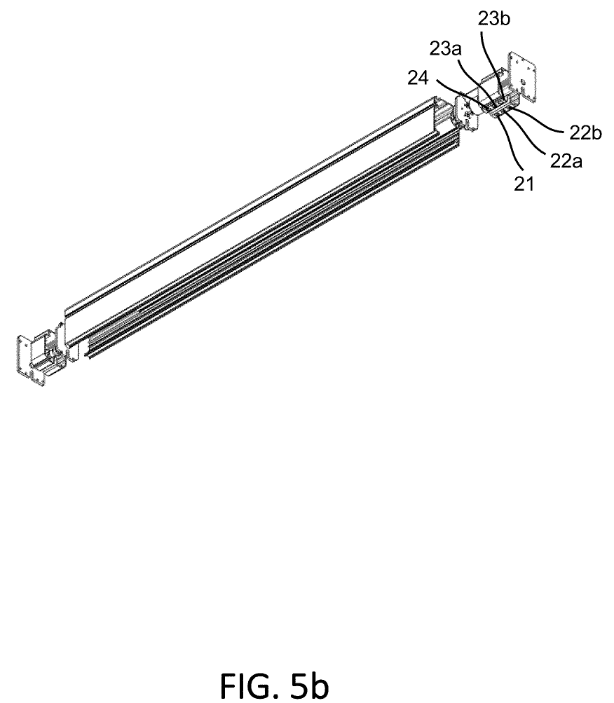

The scroll shaft and home base may be an integrated unit, as shown in FIG. 5a. Included are exemplary elements including control box 11, home base 12, scroll shaft 14, baffles 15a and 15b, spring housing 16, spring 17, and motor 18. The scroll shaft 14 includes an elongated cylindrical member that is affixed at one end to the home base.

For positioning, the home base 12 and scroll shaft 14 are typically oriented substantially horizontal, i.e., substantially parallel to a ground surface. At one end of the home base 12, a motor is attached to the home base 12 and rotates the scroll shaft 14 around its central lengthwise axis. The scroll shaft 14 holds the planar member in a rolled manner. Rotational movement of the scroll shaft 14 in one direction unrolls the planar member for display. Rotational movement of the scroll shaft 14 in the opposite direction rolls up the planar member for concealment.

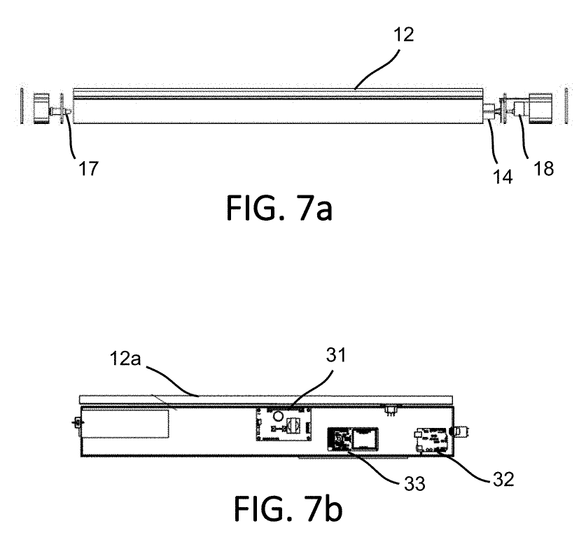

On the opposite end of the home base 12, the spring housing 16 houses a spring 17 which applies a force to one end of the scroll shaft 14. The force of the spring 17 holds the scroll shaft 14 in place within the home base. By applying a force that compresses the spring 14, the force of the spring 14 against the scroll shaft 14 is loosened or removed to provide the scroll shaft a space to be pivoted away, or otherwise disjointed, from one end of the home base 12. The other end of the scroll shaft 14 remains affixed to the home base 12. With one end pivoted away from the home base 12, a planar member attached to the scroll shaft may be slidably disengaged, or otherwise removed, and a new planar member may be inserted. A side view of the banner housing with spring 17 and motor 18 are shown in FIG. 7a.

Alternatively, the scroll shaft 14 and planar member together may be completely removed from both ends of the home base 12. This would allow a new scroll shaft 14 and planar member together to be inserted into the home base 12.

The control box houses control and power components. Turning to FIG. 5b, exemplary control components are indicated by reset button 21, manual buttons 22a and 22b, sensor input 23a and 23b, and DC input 24. These indicate manual entry points at which changes can be made to the banner display and receive input by a user. For example, reset button 21 may be used to reset a set time and/or day for displaying the banner. Alternatively, it may be used to reset the position of the banner. Manual buttons 22a and 22b indicate other manual entries that may be used to control various features and aspects of the banner display described herein (e.g., raising and lowering the planar member, etc.). Sensor input 23a and 23b indicate manual entries that may be used to control features such as lighting. Sensor input 23a and 23b indicate manual entries that may be used to control sensory input related to data such as moisture, wind, external light, etc. DC input 24 indicates manual entry for using DC power such as using DC power to power the device. Note that manual buttons and other control features may be located elsewhere in the home base.

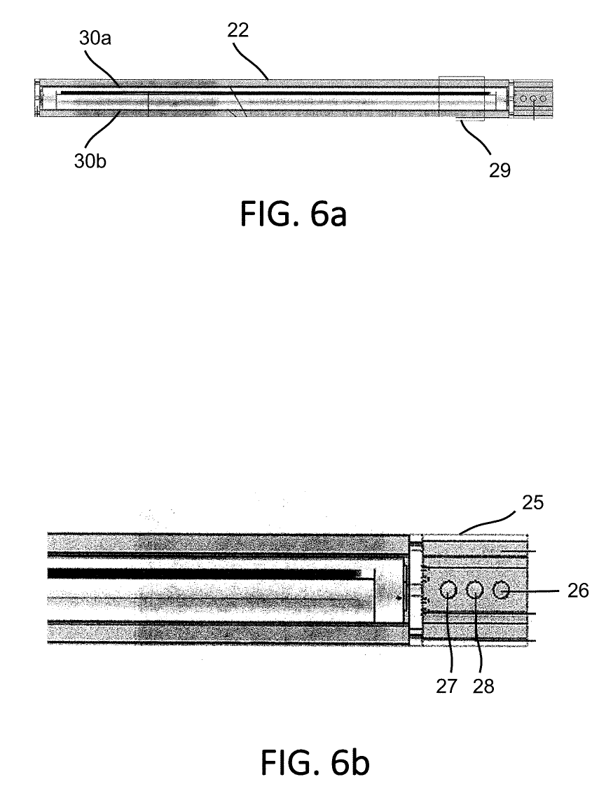

A bottom view is shown in FIG. 6A and includes LED light bars 30a and 30b on either side of a home base 22 to essentially light up both sides of a planar member. Alternatively, only one LED bar could be used. Also, an RFID reader 29 may be used, as shown attached to the home base 22.

Turning to FIG. 6b, exemplary sensors are shown in control box 25, namely, wind sensor 26, DC input or solar power input 27, and rain sensor 28.

FIG. 7b depicts a top view of an interior of the home base 12a, including a solar panel/cell 31, controller 32, and WiFi Interface 33. Not shown but that may also be included is a photocell, weather sensor, temperature sensor, wind sensor, and various other components. A lid or other protective covering may cover the interior and thereby protect the components. While shown in the interior of the home base 12a, the components may be located in other locations on the home base 12a or scroll shaft.

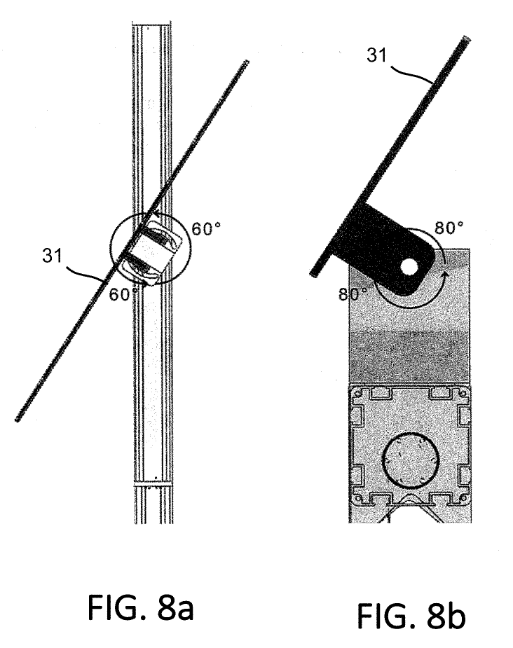

An exemplary solar power panel that may be used for the banner display is shown in FIGS. 8a and 8b. FIG. 8a illustrates a top view of a solar power panel 31 and FIG. 8b illustrates a side view of a solar power panel 31. As indicated by arrows, the panel can be rotated 60 degrees for right and left and 80 degrees for up and down for optimal solar sourcing. Other angles are also anticipated.

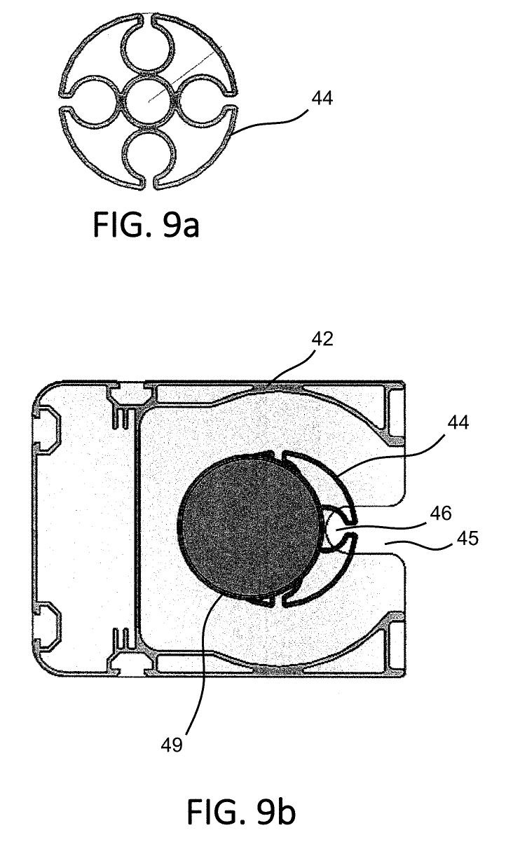

FIG. 9b illustrates a cutout side view of the home base 42 with scroll shaft 49, banner insert 44, inlet 46, and recess 45. The home base 42 and scroll shaft 49 provide openings in which an end of a planar member may be slidably inserted on the open side of the home base, or in other words, the side of the scroll shaft that pivots away from the spring, as discussed previously. The home base 42 includes the recess 45, which may be a slotted opening or other opening. The opening allows further entry to the banner insert 44 which holds the planar member to the scroll shaft. The banner insert 44 itself is a generally rounded member that is offset from a central axis of the scroll shaft 49 and which extends lengthwise along the length of the scroll shaft 49. The banner insert 44 includes an inlet 46 which has a narrow opening that leads to a larger inner opening. An edge of a planar member is inserted through the inlet 46 and along the length of the banner insert 44 so that it generally spans the length of the scroll shaft. The planar member has a thicker end so that it is held in place by the larger inner opening of the inlet 46. After being inserted within the banner insert 44, the scroll shaft is pivoted to the side of the home base and the pivoting end is pressed against the spring to be held in place. Other structures, including structures with locking means and adjustment means, may be used to attach the planar members to a scroll shaft.

Note that variations include that multiple planar members be used together. This may be accomplished with one scroll shaft or multiple scroll shafts. It is also possible that multiple banner displays be connected together in a manner that allows for simultaneous control.

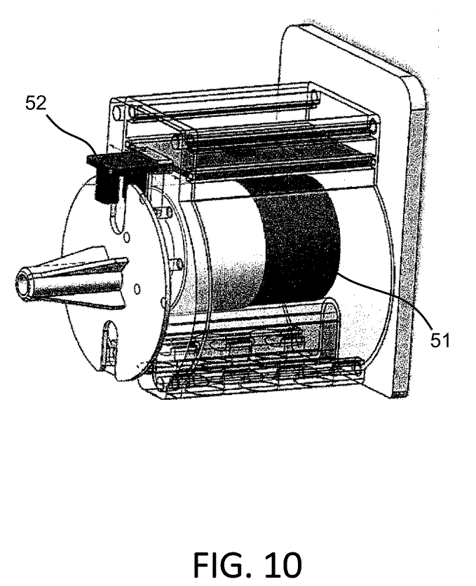

FIG. 10 illustrates an exemplary motor 51 used to rotate the scroll shaft. Any standard motor is contemplated for use. As shown, the motor includes a position sensor 52 by which the rotational movement may be monitored to determine the position of the planar member.

With reference to software related aspects, terms will now be defined to provide clarification. The term “server” generally refers to a computing device designed and/or configured to execute computer instructions, e.g., software, that may be stored on a non-transient computer readable medium. For example, but without limitation, the server may comprise a server including at least a processor, volatile memory (e.g., RAM), non-volatile memory (e.g., a hard drive or other non-volatile storage), one or more input and output ports, devices, or interfaces, and buses and/or other communication technologies for these components to connect to and communicate with each other and with other devices. Computer instructions may be stored in volatile memory, non-volatile memory, another computer-readable storage medium such as a CD or DVD, on a remote device, or any other computer readable storage medium known in the art. Communication technologies, e.g., buses or otherwise, may be wired, wireless, a combination of such, or any other computer communication technology known in the art. The server may alternatively be implemented on a virtual computing environment, or implemented entirely in hardware, or any combination of such. The server is not limited to implementation on or as a conventional server, but may additionally be implemented, entirely or in part, on a desktop computer, laptop, smart phone, personal display assistant, virtual environment, or other known computing environment or technology. A server may comprise a plurality of servers in connection with each other.

“Computing device” may refer to one of, or a combination of, a number of mobile or handheld computing devices, including handheld computers, smart phones, smart watches, tablet devices, and comparable devices that execute applications. In addition, “computing device” may refer to a device that has limited or no mobility, such as a laptop computer or a desktop computer.

“Platform” as used herein, may refer to a combination of software and hardware components that enables features herein, such as capturing information from online sources. Examples of platforms include, but are not limited to, a hosted service executed over a plurality of servers, an application executed on a single computing device, and comparable systems.

A user interface on or coupled with the computing device is capable of presenting information to a user and receiving input from a user. The computing device may be in communication with a server via any communication technology known in the art, including but not limited to direct wired communications, wired networks, direct wireless communications, wireless networks, local area networks, campus area networks, wide area networks, secured networks, unsecured networks, the Internet, the cloud, or any other computer communication technology known in the art, or any combination of such networks or communication technologies.

While some embodiments may be described in the general context of program modules that execute in conjunction with an application program that runs on an operating system on a personal computer, those skilled in the art will recognize that aspects may also be implemented in combination with other program modules.

Generally, program modules used to carry out features herein include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process or method, a computing system, or as an article of manufacture, such as a computer program product or computer readable media. The computer program product may be a computer storage medium readable by a computer system and encoding a computer program that comprises instructions for causing a computer or computing system to perform example processes. The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

To “present,” as used herein, includes but is not limited to, providing data through interface elements or controls, e.g., through a web page, application, app, audible interface, or other user interface known in the art. For example, “presenting” may comprising providing visual display elements or controls through a web browser on a computer display or smartphone display. “Presenting” may also include providing input controls or elements.

A user may interact with the application by one or more of touch input, gesture input, voice command, sound input, eye tracking, gyroscopic input, pen input, mouse input, and keyboard input. An application programming interface (API) may be a set of routines, protocols, and tools for the application or service that enable the application or service to interact or communicate with one or more other applications and services managed by separate entities.

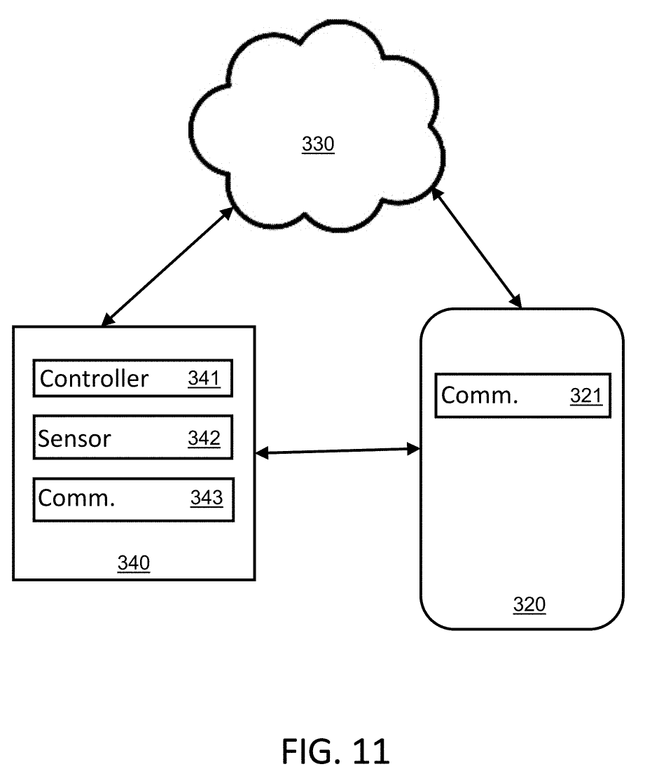

Turning to FIG. 11, an exemplary networked environment is shown for implementing features discussed herein. The environment includes an exemplary computing device in the form of a mobile device 320 in connection via a software application over a network 330. The environment further includes a smart banner display 340 that is also in connection via a controller or other device over a network 330. Communication by the mobile device 320 and the smart banner display 340 is accomplished through respective communication modules 321 and 343. Communication modules 321 and 343 enable communication, such as sending commands, receiving input, and performing any kind of exchange of information via communication technology, such as Bluetooth or Wifi technology (e.g. radio or chip). The mobile device 320 and banner display 340 may also be directly in connection with each other using respective communication modules 321 and 343.

The banner display 340 further includes a controller 341 for controlling actuation of the display features and a sensor module 342 for receiving sensory input and providing it to the controller. The controller 341 may be a microcontroller or other controller. Sensor module 342 receives sensory input described herein, such as moisture data, lighting data, wind data, motor position data, etc. Sensor module 342 provides the sensory input to the controller 341 and the controller 341 performs a banner display action (e.g. actuating the scroll, turning on the light bar, etc.) or modification (e.g. updating an event trigger) based on the sensory input.

The participant interacts with the application through a touch-enabled display interface of the mobile device 320. The computing device may alternatively include a monitor with a touch-enabled display component to provide communication to a user.

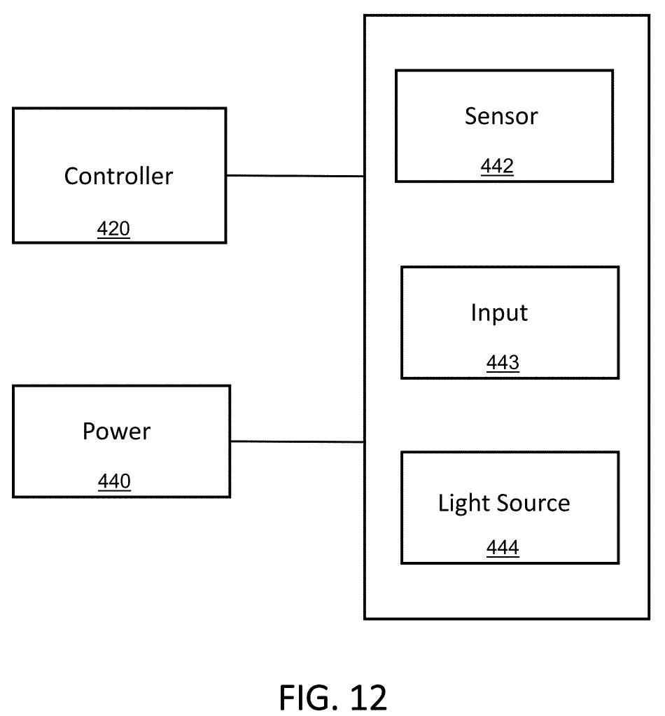

Turning to FIG. 12, a diagram is shown of exemplary components used to implement features presented herein. The components include controller module 420, power module 440, sensor module 442, input module 443, and light source module 444.

The controller module 420 communicates with, and may be controlled by, the application on the mobile device 320. In addition or alternatively, the controller is controlled by any connection described herein, manually, or by automatic functionality. The controller 420 receives data from the sensor module 442, which may be a wind sensor, light sensor, temperature sensor, moisture sensor, motor position sensor, or any other relevant sensor. For example, the controller 420 receives sensor information related to a measurement of wind. For rain and snow, the controller 420 receives moisture information. For discernment between daytime and nighttime, the controller 420 receives light information. For determining the extent of the banner display, such as being full display, partial display, or full concealment, the controller receives information from the position sensor. For the actuation of the scroll shaft, the controller module 420 turns on and off the motor.

The controller module 420 may control lights via the light source module 444, which may be one or more lights, light bars, LED light sources, etc. The controller may turn on and off the light source module for illuminating the banner display. The controller may further have advanced functionality of dimming the light source module to create various degrees of lighting.

The banner display including the controller and components may be powered by a variety of sources represented by the power module 440, including for example, solar power input, electrical input, and battery power.

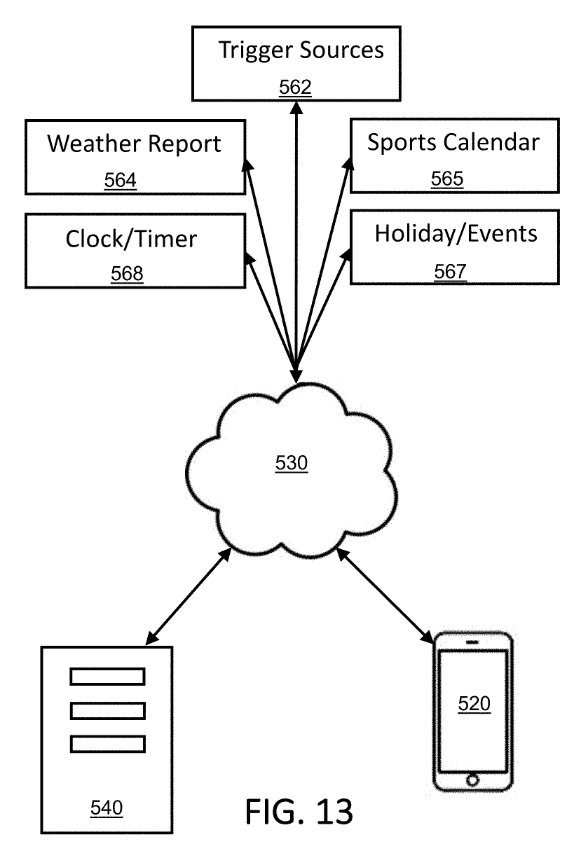

Turning to FIG. 13, an exemplary networked environment is shown including server 540, network 530, and mobile device 520. Content may be stored in or received from one or more sources, including but not limited to, server 540, or online sources 562, 564, 565, 567, and 568. Online sources may comprise servers, network resources, or Internet resources as understood in the art. Online source 562 may provide information for any condition or event relevant to banner display control. Online source 564 may provide weather information. Online source 565 may provide sports event schedule information. Online source 568 may provide clock or timer information. Online source 567 may provide holiday or event schedule information.

Content may be found in various sources like websites, emails, documents, messaging, texting, conferencing, and other forms used for communicating content. The application monitors one or more of the various sources for specific information related to a trigger event, such as a date, a time, a location, and/or a title, among others. Monitoring may include gleaning, scraping, analyzing, parsing or otherwise processing the content to detect the specific information. The resulting information may be stored on the server and presented to the user through the interface so that the user may control and/or trigger banner display actions.

The user may have the option of entering or selecting the type of information to be used as the specific information to be obtained from a given source. Specific information may further be generated by the software.

For example, weather information may be obtained from online source 564. Temperature, humidity, wind, and other weather conditions included in the obtained weather information may be used to trigger a banner display action.

Clock/timer information obtained from online source 568 may be used to monitor times or durations of times during which the banner should be displayed.

Sports information, such as game days and special events, obtained from online source 565 may be used for display action.

Holiday information obtained from online source 567 may be used to monitor holidays and national events for display action.

Other information may be obtained from online source 562 for display action. This information may be modified by the user. Also, the information may be entered by the user directly instead of being obtained online.

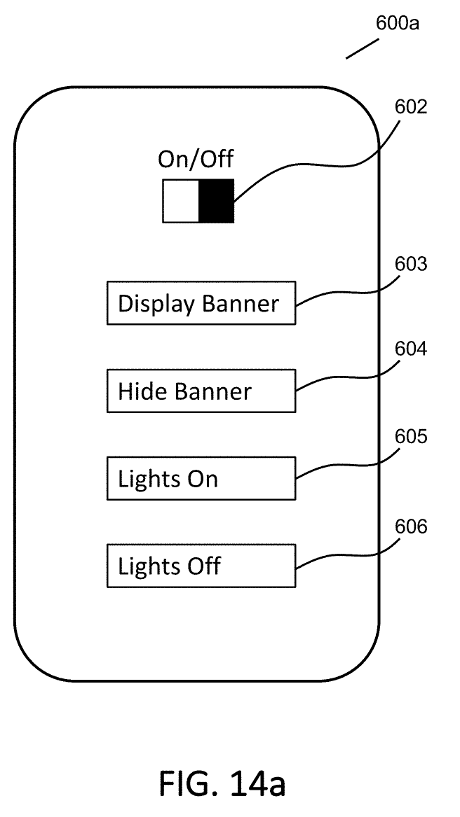

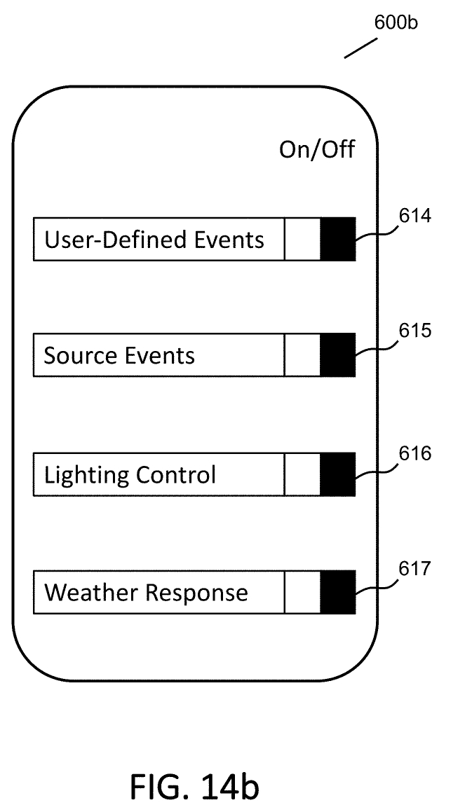

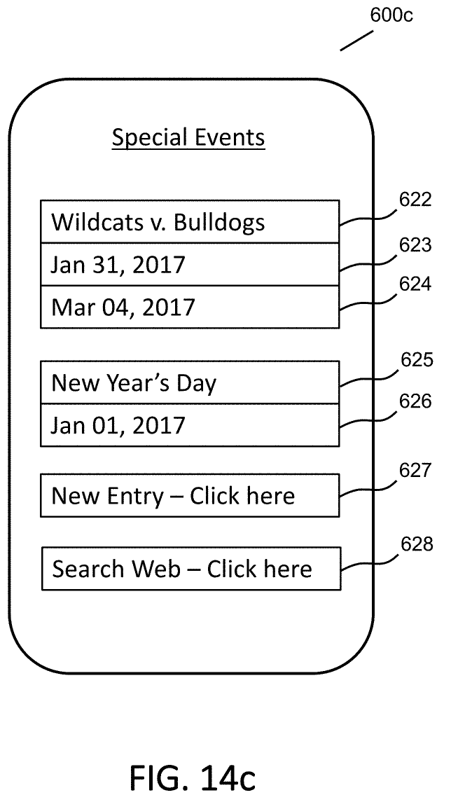

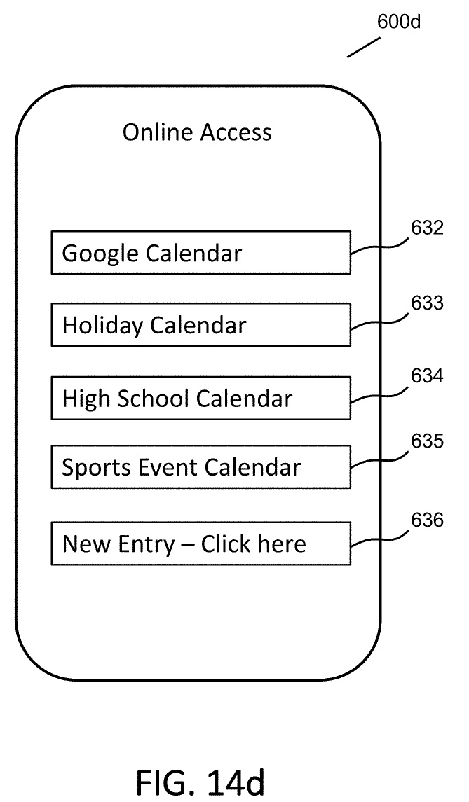

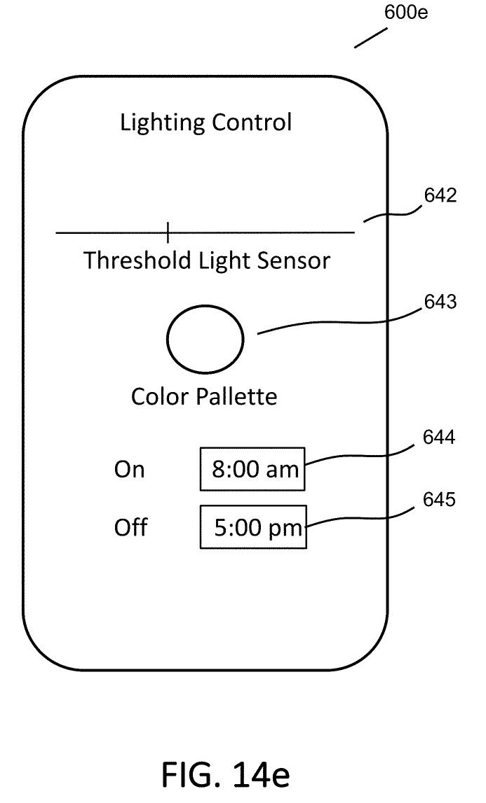

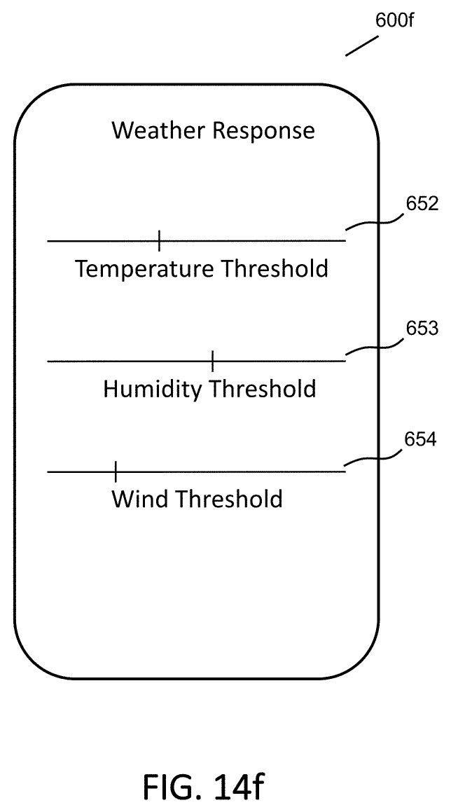

FIG. 14a shows an exemplary touch-enabled user display interface 600a. The interface 600a includes touch-enabled controls that actuate features of the display banner. For example, the ‘On/Off’ switch control 602 turns the display features on and off. The ‘Display Banner’ control 603 actuates the scroll shaft to unroll the banner or otherwise activates the display so that the banner is visible. ‘Hide Banner’ control 604 actuates the scroll shaft to roll the banner up or otherwise activates the display to conceal the banner. ‘Lights On’ control 605 turns on the lights that illuminate the banner. ‘Lights Off’ control 606 turns the lights off.

The input controls shown are in no way limiting. Further capabilities are readily anticipated. For example, capabilities may include the options of lowering and raising the banner to variable heights. Also, lights may include LED lights or other lights that may be dimmed. Capabilities may thus include dimming. Other capabilities are also anticipated.

FIG. 14b illustrates an exemplary touch-enabled user display interface 600b. The interface 600b includes input controls for enabling or disabling features of the banner display. For example, ‘User-Defined Events’ control 614 allows a user to control whether the manual entries by the user are turned on or off. For example, user-defined dates, times, weather sensor thresholds, wind sensor thresholds, and lighting times may be turned on or off. Similarly, on/off control may be had for ‘Source Events’ 615 such as online calendars, sports events, and other resources utilized outside of the user for special dates. On/off control may also be had for ‘Lighting Control’ for online daylight/nighttime services. On/off control may also be had for a ‘Weather Response’ provided by an online weather reporting services or other service. Other controls may be presented as well.

FIG. 14c illustrates an exemplary touch-enabled user display interface 600c. The interface 600c includes a listing of conditions that will trigger the display to show the banner. Conditions may comprise one or more events, dates, or other inputs as described herein, or any combination of such. Exemplary special events include ‘Wildcats v. Bulldogs’ 622 on ‘Jan. 31, 2017’ 623 and Mar. 4, 2017’ 624, and ‘New Year's Day’ 625 on ‘Jan. 1, 2017’ 626. A selection for a ‘New Entry—Click here’ control 627 may be selected to manually enter a new event and date. Also, a ‘Search Web—Click here’ control 628 may be selected to search the web or enter a web address to use an online resource or other resource that will allow the user to manually or automatically locate and retrieve or parse events and dates which will be stored and displayed on the display interface and used to trigger the display to show the banner.

FIG. 14d illustrates an exemplary touch-enabled user display interface 600d. The interface 600d lists selections of online sources that are being used to generate trigger conditions, e.g., events and dates. Example selections include ‘Google Calendar’ 632, ‘Holiday Calendar’ 633, ‘High School Calendar’ 634, and ‘Sports Event Calendar’ 635. The user may click or otherwise select a selection and make modifications to the selection. For example, the ‘Google Calendar’ 632 can be selected and the user provided with options to choose certain months, certain shared calendars, or other selections that tailor the types of events and dates that will be used as trigger events. ‘Holiday Calendar’ 633 control can be selected to allow the user to select which holidays and which timeframes can be used as trigger events. ‘High School Calendar’ 634 control may be selected to allow the user to select which school sports or which dates to track for trigger events. ‘Sports Event Calendar’ 635 control may be selected to allow the user to select which professional sports teams or which dates to track for trigger events. These selections are mere examples of the capabilities envisioned to allow the user to tailor the display of the banner.

FIG. 14e illustrates an exemplary touch-enabled user display interface 600e. The interface 600e includes examples of controls available for lighting. For example, ‘Threshold Light Sensor’ control 642 allows the user to vary the threshold amount of light that may comprise a trigger condition to turn on the lights. In this manner, as the sun sets, the lights may be turned on to illuminate the banner.

Also shown is an exemplary color palette control 643, that allows colored lights to have a user-defined hue to be selected. Also shown are time ‘On’ control 644 and time ‘Off’ control 645 which indicates the times that the lights are on and off.

FIG. 14f illustrates an exemplary touch-enabled user display interface 600f. The interface provides user-defined settings for ‘Temperature Threshold’ 652, ‘Humidity Threshold’ 653, and ‘Wind Threshold’ 654. Each threshold setting may be modified so that banner display is modified based on the value(s) of one or more parameters or inputs. So, for example, a temperature sensor that receives a threshold data temperature would indicate that the weather is too extreme to allow the banner to be displayed and the controller receiving this information would thus activate the scroll shaft to conceal the banner.

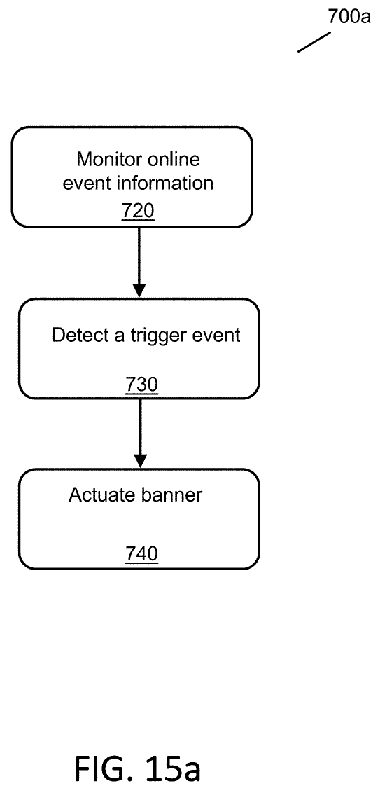

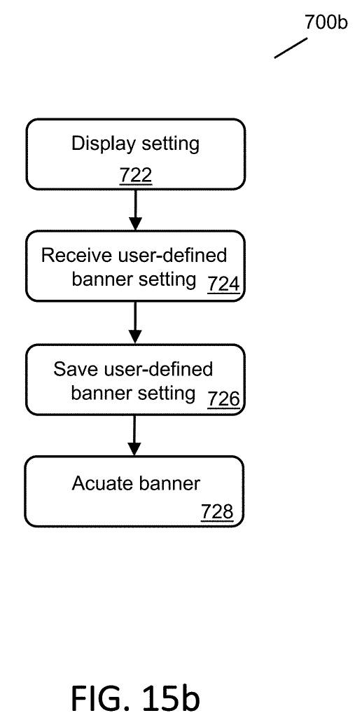

FIG. 15a illustrates a flow diagram of a process 700a used to perform a banner display action according to embodiments presented herein. The process 700a may be implemented on a computing device, such as mobile device 320 and 520, and other devices discussed herein.

The process 700a begins with step 720, in which an application on the mobile device 520 monitors event information. This step includes monitoring calendars, weather reports, sporting events, emails, documents, and other information. This step 702 may include processing data to identify an event, time, duration, or other condition. This step may further include storing data and forming structures to handle the data.

At step 720, the application processes received display conditions to determine when one or more trigger conditions have occurred. At step 740, the controller performs a banner display action based on the identified trigger condition. The banner display action may comprise displaying, concealing, partially displaying, partially concealing the banner, or turning lights on or off or brighter or dimmer, or any other banner display action disclosed herein or known in the art.

In FIG. 15b, a flow diagram is presented of a process 700b used to apply user-defined settings to modify banner display. In step 722, input controls for user-defined settings, such as the user-defined settings in FIGS. 6a-f, are provided to the user. At step 724 the application receives a user defined setting. At step 728, the controller determines, based on the user-defined settings, to modify display of the banner.

The processes may be implemented with fewer or additional steps, as well as in a different order. Also, the processes may be executed by one or more processors operated on one or more computing devices, one or more processor cores, specialized processing devices, and/or general purpose processors, among other processing environments.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

1. A smart banner display, comprising:
a home base;
a scroll shaft located within the home base and configured to rotate around an axis relative to the home base;
a banner removably attached to the scroll shaft so that the banner is raised and lowered as the scroll shaft rotates; and
a motor that rotates the scroll shaft in any rotational direction based upon instructions from a controller.

2. The banner display in claim 1, wherein the controller is a microcontroller that stores and executes instructions for the banner display.

3. The banner display in claim 1, wherein the controller includes user parameter storage and executable programming such that the instructions from the controller at least in part are based upon processing by the programming of user parameters.

4. The banner display in claim 1, wherein the scroll shaft is integrated with the home base so as not to be removable.

5. The banner display in claim 1, wherein the scroll shaft is removably attached at ends to the home base with a locking structure.

6. The banner display in claim 1, further comprising an inlet along a length of the scroll shaft in which an end of a banner may be inserted and thereby attached.

7. The banner display in claim 1, further comprising a position sensor that determines the rotational position of the scroll shaft relative to the home base.

8. The banner display in claim 1, further comprising a light source on the home base, the light source configured to illuminate the banner.

9. The banner display in claim 1, further comprising one or more of a solar power input, electrical input, and battery for providing power to the actuation of the banner display.

10. The banner display in claim 1, further comprising a rain sensor for detecting moisture, conditional display of the banner based on signals received by the controller from the rain sensor including raising the banner upon a threshold detection of moisture indicating inclement weather.

11. The banner display in claim 1, further comprising a wind sensor for detecting wind, conditional display of the banner based on signals received by the controller from the wind sensor including raising the banner upon a threshold detection of wind indicating inclement weather.

12. The banner display in claim 1, further comprising a weight stick on a free end of the banner to weight the banner down.

13. A method for controlling a smart banner display, comprising:
displaying on a user interface one or more selections related to control of the banner display;
receiving a selection from the one or more selections;
storing the selection;
providing the selection to a controller; and
performing through the controller, based on the selection, an actuation in relation to the banner display.

14. The method of claim 13, wherein the selection includes one or more of controls and parameter settings for lighting, wind, power, rain, motor, and up/down banner movement.

15. The method of claim 13, wherein the selection includes a link to one or more of an online sports calendar for sports events or other related reference that can be synced to the banner display for automatic display on one or more event days.

16. The method of claim 13, wherein the selection includes a link to an online website that contains weather information that can be synced to the banner display for automatic display within a set weather range or threshold.

17. The method of claim 13, wherein the selection includes a choice of a particular banner to display out of a plurality of banners.

18. The method of claim 13, further comprising
monitoring, through an application, online event information;
detecting a trigger event; and
actuating a banner feature in relation to the trigger event.

19. A method, implemented at a computer system that includes one or more processors, of procuring a unique travel package that is tailored to a user's interests, the method comprising:
displaying on a user interface one or more selections related to control of the banner display;
receiving a selection from the one or more selections;
storing the selection;
providing the selection to a controller; and
performing through the controller, based on the selection, an actuation in relation to the banner display.

20. The method of claim 19, further comprising:
monitoring, through the application, online event information;
detecting a trigger event; and
actuating a banner feature in relation to the trigger event.
